(19) United States
(12) Patent Application Publication
(10) Pub. No.: US 2024/0267487 A1
(43) Pub. Date: Aug. 8, 2024

(54) VIDEO TRANSMISSION APPARATUS, VIDEO RECEIVING APPARATUS, VIDEO TRANSMISSION METHOD, VIDEO RECEIVING METHOD, VIDEO TRANSMISSION SYSTEM, AND PROGRAM

(71) Applicant: NIPPON TELEGRAPH AND TELEPHONE CORPORATION, Tokyo (JP)

(72) Inventors: Yasuhiro MOCHIDA, Musashino-shi, Tokyo (JP); Takuro YAMAGUCHI, Musashino-shi, Tokyo (JP); Daisuke SHIRAI, Musashino-shi, Tokyo (JP); Takahiro YAMAGUCHI, Musashino-shi, Tokyo (JP)

(21) Appl. No.: 18/567,760

(22) PCT Filed: Jun. 8, 2021
(86) PCT No.: PCT/JP2021/021703

§ 371 Date: Dec. 6, 2023

(51) Int. Cl. H04N 7/08; H04N 7/01

(52) U.S. Cl. CPC H04N 7/0806; H04N 7/0117

(57) ABSTRACT

A transmission device 10 includes: an SDI input unit 11 that inputs a plurality of sub-pictures obtained by dividing a picture from a plurality of links of an SDI; a mapping management unit 12 that selects an ST 2110 mapping scheme for pixel data to a packet on the basis of a combination of an SDI mapping scheme for the pixel data in the SDI and the RP 2110-23 compatibility; and an ST 2110 output unit 13 that stores the pixel data of the picture in the packet in accordance with the ST 2110 mapping scheme and outputs the packet. A reception device 30 includes: an ST 2110 input unit 31 that inputs a packet in which pixel data is stored; a mapping management unit 32 that selects an SDI mapping scheme for the pixel data to a plurality of links of an SDI on the basis of a combination of an ST 2110 mapping scheme for the pixel data in the packet and the RP 2110-23 compatibility; and an SDI output unit 33 that outputs the pixel data of the picture from the plurality of links of the SDI in accordance with the SDI mapping scheme.

### TECHNICAL FIELD

The present invention relates to a video transmission device, a video reception device, a video transmission method, a video reception method, a video transmission system, and a program.

### BACKGROUND ART

A serial digital interface (SDI) transmits uncompressed video and audio by a circuit switching system using a coaxial cable. In transmission of a high-resolution video, a plurality of coaxial cables is used to divide a picture into sub-pictures and map the sub-pictures to a plurality of SDI links. Hereinafter, a scheme of dividing a picture into sub-pictures and mapping pixel data of the sub-pictures to a plurality of SDI links will be referred to as an SDI mapping scheme.

There is a plurality of schemes in the SDI mapping scheme. Specifically, the SDI mapping scheme includes two methods of a Square Division (SQD) scheme and a 2-sample Interleave (2SI) scheme. In the SQD scheme, as illustrated in FIG. 1, a picture is divided into four equal parts vertically and horizontally to create sub-pictures. In the 2SI scheme, as illustrated in FIG. 2, sub-pictures are created by dividing pixel data in units of two pixels. For example, a quad link 12G-SDI is used for transmission of 8K video (4320 p, 59.94 fps). The 8K video is divided into four sub-pictures by the SQD scheme or the 2SI scheme, and the four sub-pictures are respectively mapped to four links A, B, C, and D of the quad link 12G-SDI. Regarding the SDI mapping scheme for 8K video, only the 2SI scheme is defined in SMPTE ST 2082-12 (Non Patent Literature 1), but actually, there are also many devices that use the SQD scheme.

SMPTE ST 2110-20 (Non Patent Literature 2) describes a method of storing pixel data in a Real-time Transport Protocol (RTP) payload and transmitting uncompressed video by an Internet Protocol (IP) packet switching scheme. In the ST 2110-20, the pixel data of each frame is mapped to an RTP payload in raster scan order.

SMPTE RP 2110-23 (Non Patent Literature 3) describes a method of dividing a high-resolution video or a high-frame-rate video in a spatial direction or a temporal direction, mapping sub-pictures on a plurality of ST 2110 flows (streams), and transmitting the sub-pictures. The SQD scheme or the 2SI scheme is used for sub-picture division in the spatial direction. Each ST 2110 flow transmitting a sub-picture stores pixel data of the sub-picture in raster scan order. Hereinafter, a scheme of mapping pixel data to an ST 2110 flow will be referred to as an ST 2110 mapping scheme. The ST 2110 mapping scheme includes both a case where a picture is mapped to a single flow without being divided and a case where a picture is divided into sub-pictures and mapped to a plurality of ST 2110 flows.

In the ST 2110, a Session Description Protocol (SDP) is used to describe information regarding the ST 2110 flow, such as resolution and a frame rate. When the RP 2110-23 is used, the ST 2110 mapping scheme is also described in the SDP. By sharing the SDP between a transmission side and a reception side, normal transmission and reception can be performed.

### CITATION LIST

### Non Patent Literature

Non Patent Literature 1: SMPTE ST 2082-12:2016 4320-line and 2160-line Source Image and Ancillary Data Mapping for Quad-link 12G-SDI
Non Patent Literature 2: SMPTE ST 2110-20:2017 Professional Media Over Managed IP Networks: Uncompressed Active Video
Non Patent Literature 3: SMPTE RP 2110-23:2019 Single Video Essence Transport over Multiple ST 2110-20 Streams

### SUMMARY OF INVENTION

### Technical Problem

In an environment where the SDI and the ST 2110 are mixed, it is necessary to convert both. However, a wait delay is required depending on a combination of the SDI mapping scheme and the ST 2110 mapping scheme before and after conversion.

For example, in a case of 8K video, in conversion from the SQD division quad link 12G-SDI to the ST 2110 single flow, as illustrated in FIG. 3, not to deplete buffers for packet transmission, a wait delay of ½ of a frame period TF (17 ms) is required for sending out the ST 2110 single flow. FIG. 3 illustrates that the 1st line to the 2160th line of the 8K video are sequentially input in one frame period on an AB link, the 2161th line to the 4320th line of the 8K video are sequentially input in one frame period on a CD link, and the 1st line to the 4320th lines are sequentially sent out in one frame period in the ST 2110 single flow from a timing of ½ TF.

In conversion from the ST 2110 single flow to the SQD division quad link 12G-SDI, as illustrated in FIG. 4, it is required to wait for the 2161th line to be sent out on the CD link at input from the ST 2110 single flow, and thus, a wait delay of ½ of the frame period TF (17 ms) is required for sending out from SDI links. FIG. 4 illustrates that the 1st line to the 4320th line are sequentially received in the frame period TF in the ST 2110 single flow, the 1st line to the 2160th line are sent out on the AB link from the timing of ½ of the frame period TF, and the 2161th line to the 4320th line are sent out on the CD link.

In conversion from the 2SI division quad link 12G-SDI to the ST 2110 single flow, as illustrated in FIG. 5, not to deplete buffers for packet transmission, a wait delay of one line period TL (4 μs) is required for sending out the ST 2110 single flow. FIG. 5 illustrates that one line is input from each of the AB link and the CD link, and sent out in raster scan order in the ST 2110 single flow from a timing of TL.

In conversion from the ST 2110 single flow to the 2SI division quad link 12G-SDI, as illustrated in FIG. 6, it is required to wait for the second line to be sent out on the CD link at input from the ST 2110 single flow, and thus, a wait delay of one line period TL (4 μs) is required for sending out from SDI links. FIG. 6 illustrates that reception is performed in raster scan order in the ST 2110 single flow, and one line is sent out from each of the AB link and the CD link from the timing of TL.

Also in a case where conversion is performed between different division schemes, a wait delay is required. For example, in a case where the 8K video input from the 2SI division quad link 12G-SDI is converted into ST 2110 four flows by SQD division, a wait delay of ½ frame period is required. Specifically, when the 8K video is input by the 2SI division quad link 12G-SDI, the 2161th line is input ½ frame period after the input of the 1st line, and thus, in a case where conversion into the ST 2110 four flows is performed by SQD division, a wait delay of ½ frame period is required. In addition, in a case where the 8K video input from the SQD division quad link 12G-SDI is converted into ST 2110 four flows by 2SI division, a wait delay of one line period is required. Specifically, when the 8K video is input by the SQD division quad link 12G-SDI, the second line is input after one line period from the input of the first line, and thus, in a case where conversion into the ST 2110 four flows is performed by 2SI division, a wait delay of one line period is required.

Note that, in a case where conversion is performed between the same division schemes, pixel data only needs to be output in the order of input for each sub-picture, and thus, a wait delay is unnecessary.

Further, in the ST 2110, it is defined to arrange the pixel data in raster scan order, so that in conversion from the SDI to the ST 2110 single flow using a plurality of links, the conversion cannot be correctly performed unless it is determined whether the SDI mapping scheme is the 2SI scheme or the SQD scheme.

The present invention has been made in view of the above, and an object thereof is to convert the SDI and the ST 2110 with a low delay.

### Solution to Problem

A video transmission device of an aspect of the present invention is a video transmission device that stores pixel data of a picture input from a serial digital interface in a packet and transmits the packet, the video transmission device including: an input unit that inputs a plurality of sub-pictures obtained by dividing the picture from a plurality of links of the serial digital interface; a mapping management unit that selects a second mapping scheme for storing the pixel data in the packet on the basis of a combination of a first mapping scheme for the pixel data in the serial digital interface and presence or absence of a multi-flow transmission function of the video transmission device itself; and an output unit that stores the pixel data of the picture in the packet in accordance with the second mapping scheme and outputs the packet.

A video reception device of an aspect of the present invention is a video reception device that outputs pixel data of a picture stored in a packet from a serial digital interface, the video reception device including: an input unit that inputs the packet in which the pixel data is stored; a mapping management unit that selects a first mapping scheme for the pixel data in the serial digital interface on the basis of a combination of a second mapping scheme for the pixel data stored in the packet and presence or absence of a multi-flow reception function of the video reception device itself; and an output unit that outputs the pixel data of the picture from a plurality of links of the serial digital interface in accordance with the first mapping scheme.

A video transmission system of an aspect of the present invention is a video transmission system including a video transmission device, a video reception device, and a control device, the video transmission device storing pixel data of a picture input from a serial digital interface in a packet to transmit the packet, the video reception device receiving the packet to output the pixel data of the picture stored in the packet from the serial digital interface, in which the video transmission device notifies the control device of a first mapping scheme for the pixel data in the serial digital interface and presence or absence of a multi-flow transmission function of the video transmission device itself, the video reception device notifies the control device of presence or absence of a multi-flow reception function of the video reception device itself, and the control device selects a second mapping scheme for storing the pixel data in the packet in the video transmission device and the first mapping scheme for the pixel data in the serial digital interface in the video reception device on the basis of a combination of the first mapping scheme, the presence or absence of the multi-flow transmission function, and the presence or absence of the multi-flow reception function, notifies the video transmission device of the second mapping scheme, and notifies the video reception device of the first mapping scheme.

### Advantageous Effects of Invention

According to the present invention, the SDI and the ST 2110 can be converted with a low delay.

### BRIEF DESCRIPTION OF DRAWINGS

FIG. 1 is a diagram for explaining division of an SQD scheme.

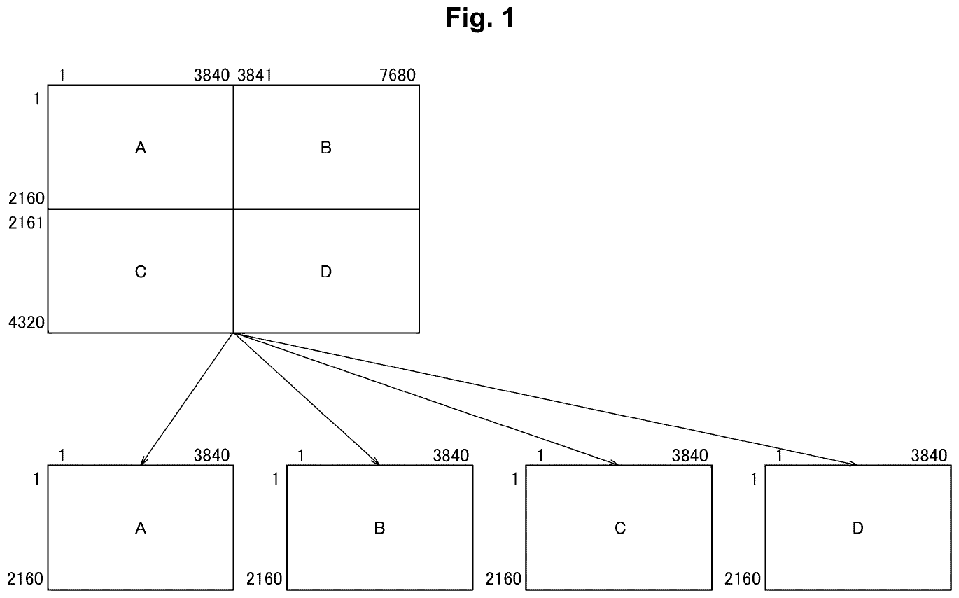

FIG. 2 is a diagram for explaining division of a 2SI scheme.

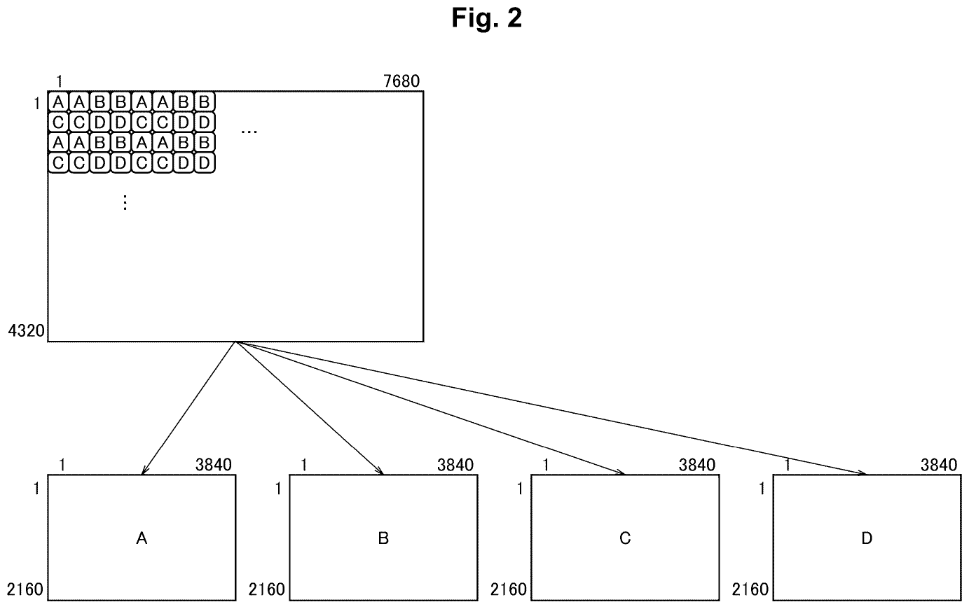

FIG. 3 is a diagram for explaining that a delay is required to send out pixel data subjected to SQD division input from SDI links in the ST 2110 single flow.

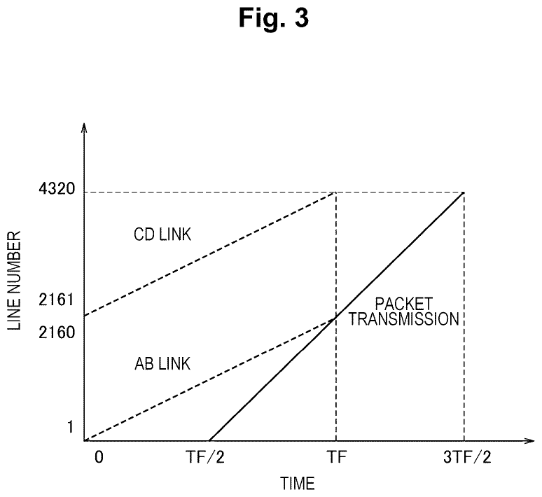

FIG. 4 is a diagram for explaining that a delay is required to perform SQD division on pixel data received in the ST 2110 single flow and to send the pixel data from SDI links.

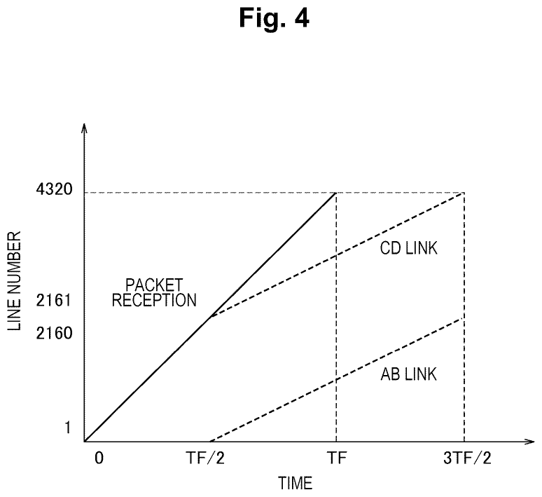

FIG. 5 is a diagram for explaining that a delay is required to send out pixel data subjected to 2SI division input from SDI links in the ST 2110 single flow.

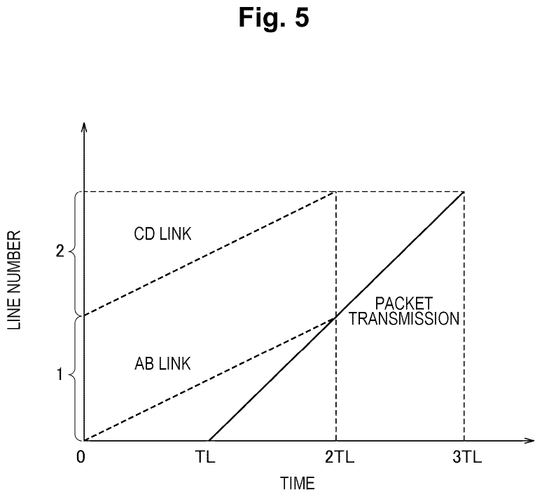

FIG. 6 is a diagram for explaining that a delay is required to perform 2SI division on pixel data received in the ST 2110 single flow and send out the pixel data from SDI links.

FIG. 7 is a functional block diagram illustrating an example of configurations of a transmission device and a reception device of a present embodiment.

FIG. 8 is a flowchart illustrating an example of a flow of processing performed by the transmission device.

FIG. 9 is a flowchart illustrating an example of a flow of processing performed by the reception device.

FIG. 10 is a diagram illustrating an example of a configuration of a video transmission system including a control device.

FIG. 11 is a sequence diagram illustrating an example of a flow of processing performed by the video transmission system.

FIG. 12 is a flowchart illustrating an example of a flow of processing performed by the control device.

FIG. 13 is a diagram illustrating an example of a hardware configuration of the transmission device, the reception device, and the control device.

### DESCRIPTION OF EMBODIMENTS

### [Configuration of Video Transmission System]

Hereinafter, an embodiment of the present invention will be described with reference to the drawings.

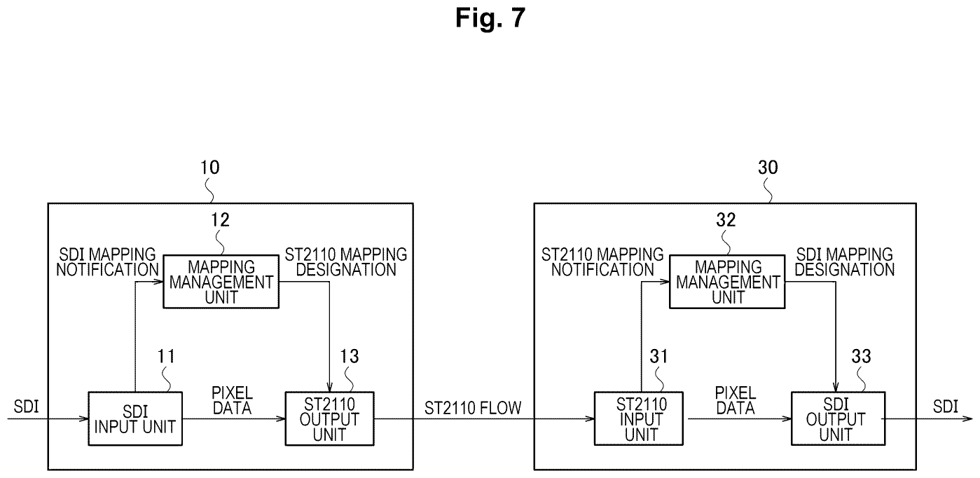

A transmission device 10 and a reception device 30 of the present embodiment will be described with reference to FIG. 7. The transmission device 10 illustrated in the figure is a device that converts 8K video input in the quad link 12G-SDI into the ST 2110, and the reception device 30 is a device that converts 8K video input in the ST 2110 into the quad link 12G-SDI.

The transmission device 10 includes an SDI input unit 11, a mapping management unit 12, and an ST 2110 output unit 13.

The SDI input unit 11 inputs a plurality of sub-pictures obtained by dividing a picture (input video) from a plurality of SDI links (quad link 12G-SDI), respectively. The SDI input unit 11 determines an SDI mapping scheme for the input video by using a correlation coefficient between the sub-pictures. The SDI input unit 11 uses properties that the correlation coefficient between sub-pictures is small in an SOD scheme and the correlation coefficient between sub-pictures is large in a 2SI scheme. In the SQD scheme, since pixel data is divided into four to create sub-pictures, the correlation coefficient between sub-pictures is small. In the 2SI scheme, since pixel data is finely divided to create sub-pictures, the correlation coefficient between sub-pictures is large. As an example, Table 1 illustrates correlation coefficients between sub-pictures in a case where an 8K-resolution natural image is divided by the SQD scheme or the 2SI scheme.

TABLE 1

| Correlation | | | | | | |
|---|---|---|---|---|---|---|
| between sub- | | | | | | |
| pictures | A − B | A − C | A − D | B − C | B − D | C − D |
| SQD | 0.6396 | −0.2100 | 0.1946 | −0.3755 | 0.3376 | −0.0962 |
| 2SI | 0.9971 | 0.9981 | 0.9954 | 0.9953 | 0.9981 | 0.9966 |

The correlation coefficient greater than or equal to 0.99 is obtained in the 2SI scheme, whereas the correlation coefficient in the SQD scheme is small. For example, with the correlation coefficient 0.99 as a threshold value, the SDI input unit 11 may determine 2SI in a case where the correlation coefficient is greater than or equal to the threshold value, and may determine SQD in a case where the correlation coefficient is less than the threshold value. A determination result is passed to the mapping management unit 12. The correlation coefficient between images X and Y is calculated by the following formula.

$$r = \frac{{\sum }_{m} {\sum }_{n} ( {X}_{m n} - \overline{X} ) ( {Y}_{m n} - \overline{Y} )}{\sqrt{( {\sum }_{m} {\sum }_{n} {( {X}_{m n} - \overline{X} )}^{2} ) ( {\sum }_{m} {\sum }_{n} {( {Y}_{m n} - \overline{Y} )}^{2} )}} \qquad [ Math . 1 ]$$

Here, Xmn is a pixel value of the mth row and the nth column of the image X, and Ymn is a pixel value of the mth row and the nth column of the image Y. In addition, X (with bar on top) is an average value of pixel values of the image X, and Y (with bar on top) is an average value of pixel values of the image Y.

Note that the SDI mapping scheme may be determined by several frames at the start of picture input. In addition, the transmission device 10 may be notified of the SDI mapping scheme for the input video from the outside.

The mapping management unit 12 selects an ST 2110 mapping scheme that enables conversion with the lowest delay by logic to be described later based on a combination of the SDI mapping scheme for the input video and the RP 2110-23 compatibility of the transmission device 10 itself, and sets the selected scheme in the ST 2110 output unit 13. The ST 2110 mapping scheme includes a single flow in which pixel data is not divided, ST 2110 four flows divided by the 2SI scheme, and ST 2110 four flows divided by the SQD scheme.

The mapping management unit 12 may generate an SDP in which the ST 2110 mapping scheme is described simultaneously with setting the selected scheme in the ST 2110 output unit 13. The generated SDP may be transmitted to the reception device 30 by using Networked Media Open Specifications (NMOS) Interface Specification (IS)-05 that is a common control standard for the ST 2110 transmission and reception devices.

The ST 2110 output unit 13 sends out an ST 2110 flow obtained by mapping pixel data received from the SDI input unit 11 by the designated ST 2110 mapping scheme. For example, when 8K video is sent out in the ST 2110 single flow, pixel data of the 8K video is sent out in one flow in raster scan order without dividing the 8K video. When the 8K video is sent out by using the RP 2110-23 (multi-flow transmission function), the 8K video is divided into four sub-pictures by a designated ST 2110 mapping scheme (2SI scheme or SQD scheme), and pixel data of the four sub-pictures are respectively sent out in four flows in raster scan order. In a case where the SDI mapping scheme and the ST 2110 mapping scheme are the same, for each of the sub-pictures input by the SDI input unit 11, the pixel data can be stored in a packet of a corresponding ST 2110 flow in raster scan order and sent out without delay.

The reception device 30 includes an ST 2110 input unit 31, a mapping management unit 32, and an SDI output unit 33.

The ST 2110 input unit 31 inputs the ST 2110 flow and determines the ST 2110 mapping scheme. In a case where the ST 2110 flow is received in the RP 2110-23 (multi-flow reception function), the ST 2110 input unit 31 determines the ST 2110 mapping scheme by using a cross-correlation between the sub-pictures as in Example 1. In a case where reception is performed in the single flow, it is assumed that the pixel data is assumed to be arranged in raster scan order. The ST 2110 input unit 31 notifies the mapping management unit 32 of a determination result for the ST 2110 flow. Alternatively, in a case where an SDP related to received flow information is received, the ST 2110 mapping scheme may be acquired from the SDP.

The mapping management unit 32 determines an SDI mapping scheme that enables conversion with the lowest delay by logic to be described later based on an ST 2110 mapping scheme for an input packet, and sets the selected scheme in the SDI output unit 33.

The SDI output unit 33 maps the pixel data received from the ST 2110 input unit 31 by the designated SDI mapping scheme and outputs the pixel data to SDI links. For example, 8K video is divided into four sub-pictures by a designated SDI mapping scheme (2SI scheme or SQD scheme), and pixel data of the four sub-pictures are respectively output to four SDI links in raster scan order. In a case where the ST 2110 mapping scheme and the SDI mapping scheme are the same, for each of the ST 2110 four flows input by the ST 2110 input unit 31, the pixel data stored in a packet of the flow can be output on a corresponding SDI link in raster scan order without delay.

### [Operation of Video Transmission System]

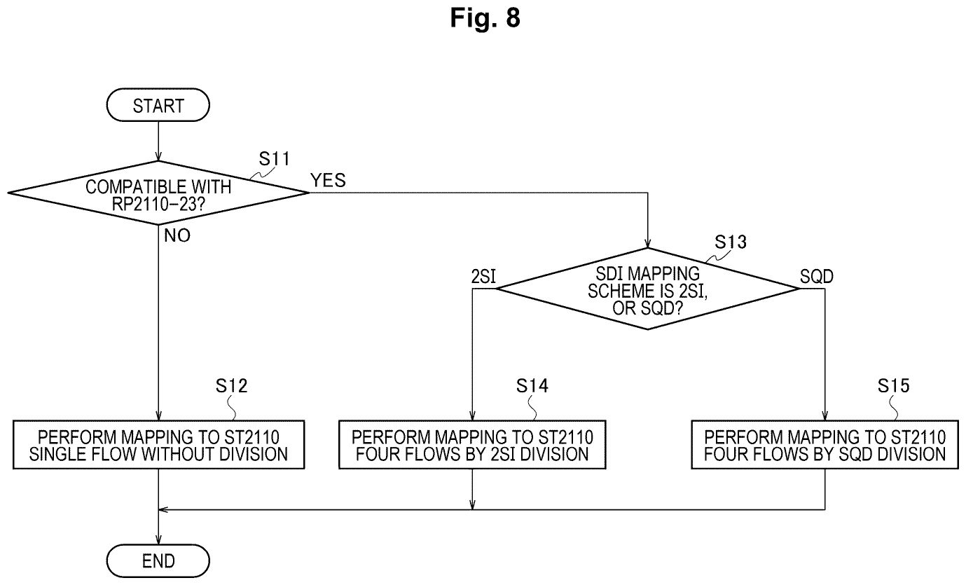

Next, an example of a method of selecting an ST 2110 mapping scheme by the mapping management unit 12 of the transmission device 10 will be described with reference to a flowchart of FIG. 8.

In step S11, the mapping management unit 12 determines whether or not the transmission device 10 is compatible with the RP 2110-23.

In a case where the transmission device 10 is not compatible with the RP 2110-23, in step S12, the mapping management unit 12 selects the single flow in which a flow for transmitting video is not divided as the ST 2110 mapping scheme.

In a case where the transmission device 10 is compatible with the RP 2110-23, in step S13, the mapping management unit 12 determines whether the SDI mapping scheme for the input video is the 2SI scheme or the SQD scheme.

In a case where the SDI mapping scheme is the 2SI scheme, in step S14, the mapping management unit 12 selects the 2SI scheme as the ST 2110 mapping scheme.

In a case where the SDI mapping scheme is the SQD scheme, in step S15, the mapping management unit 12 selects the SQD scheme as the ST 2110 mapping scheme.

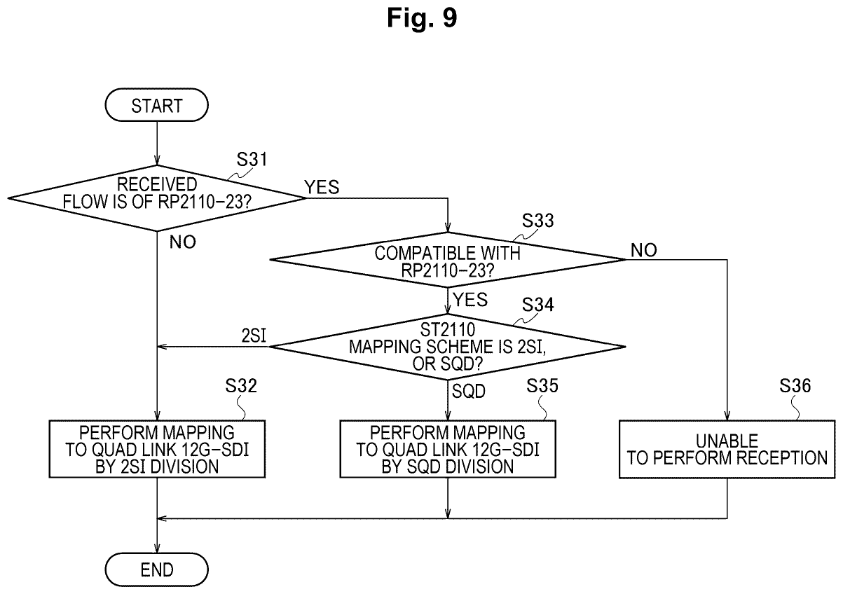

Next, an example of a method of selecting an SDI mapping scheme by the mapping management unit 32 of the reception device 30 will be described with reference to the flowchart of FIG. 9.

In step S31, the mapping management unit 32 determines whether or not a received flow is of the RP 2110-23.

In a case where the received flow is not of the RP 2110-23, for example, in a case of the single flow, in step S32, the mapping management unit 32 selects the 2SI scheme as the SDI mapping scheme.

In a case where the received flow is of the RP 2110-23, in step S33, the mapping management unit 32 determines whether or not the reception device 30 is compatible with the RP 2110-23.

In a case where the reception device 30 is compatible with the RP 2110-23, in step S34, the mapping management unit 32 determines whether the ST 2110 mapping scheme for the received flow is the 2SI scheme or the SQD scheme.

In a case where the ST 2110 mapping scheme is the 2SI scheme, in step S32, the mapping management unit 32 selects the 2SI scheme as the SDI mapping scheme.

In a case where the ST 2110 mapping scheme is the SQD scheme, in step S35, the mapping management unit 32 selects the SQD scheme as the SDI mapping scheme.

In a case where the reception device 30 is not compatible with the RP 2110-23, in step S36, the mapping management unit 32 determines that the ST 2110 flow cannot be received.

### [Another Video Transmission System]

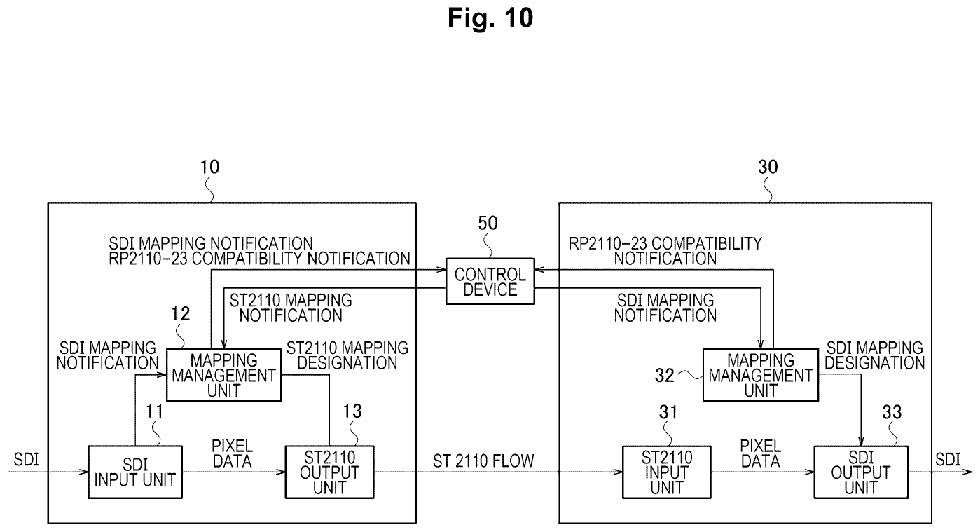

An example of a configuration for controlling mapping between the transmission device 10 and the reception device 30 by using a control device 50 will be described with reference to FIG. 10. A video transmission system illustrated in FIG. 10 includes the transmission device 10, the reception device 30, and the control device 50.

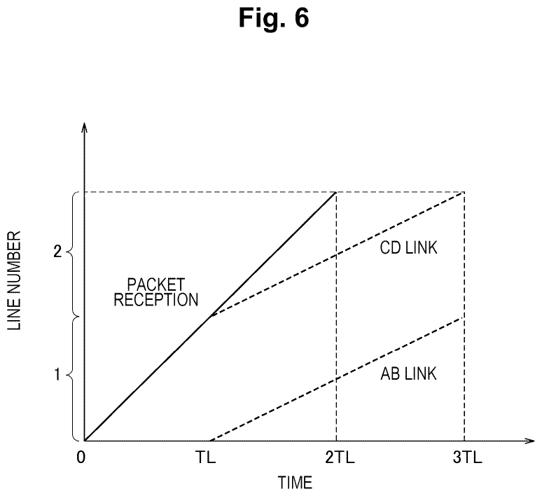

The transmission device 10 includes the SDI input unit 11, the mapping management unit 12, and the ST 2110 output unit 13. The SDI input unit 11 and the ST 2110 output unit 13 are similar to the SDI input unit 11 and the ST 2110 output unit 13 of the transmission device 10 in FIG. 6.

The mapping management unit 12 transmits an SDI mapping scheme for the input video and the RP 2110-23 compatibility of the transmission device 10 itself to the control device 50, receives an ST 2110 mapping scheme that enables conversion with the lowest delay from the control device 50, and sets the ST 2110 mapping scheme in the ST 2110 output unit 13.

The control device 50 receives the SDI mapping scheme for the input video and the RP 2110-23 compatibility from the transmission device 10, and receives the RP 2110-23 compatibility from the reception device 30. The control device 50 determines the ST 2110 mapping scheme in the transmission device 10 and an SDI mapping scheme in the reception device 30 that enables conversion with the lowest delay on the basis of a combination of the SDI mapping scheme for the input video of the transmission device 10, the RP 2110-23 compatibility of the transmission device 10, and the RP 2110-23 compatibility of the reception device 30.

The reception device 30 includes the ST 2110 input unit 31, the mapping management unit 32, and the SDI output unit 33. The ST 2110 input unit 31 and the SDI output unit 33 are similar to the ST 2110 input unit 31 and the SDI output unit 33 of the reception device 30 in FIG. 6, but the ST 2110 input unit 31 in FIG. 10 does not determine the ST 2110 mapping scheme.

The mapping management unit 32 transmits the RP 2110-23 compatibility of the reception device 30 itself to the control device 50, receives the SDI mapping scheme that enables conversion with the lowest delay from the control device 50, and sets the SDI mapping scheme in the SDI output unit 33.

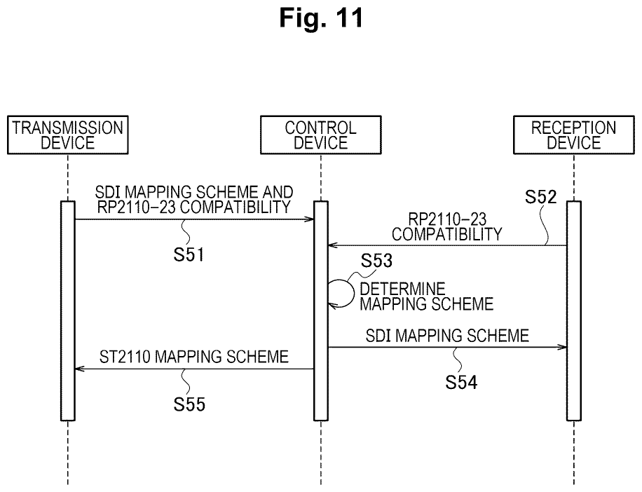

An example of a flow of processing performed by the video transmission system will be described with reference to a sequence diagram illustrated in FIG. 11.

In step S51, the transmission device 10 transmits the SDI mapping scheme for the input video and the RP 2110-23 compatibility of the transmission device 10 itself to the control device 50.

In step S52, the reception device 30 transmits the RP 2110-23 compatibility of the reception device 30 itself to the control device 50.

In step S53, the control device 50 determines the ST 2110 mapping scheme in the transmission device 10 and the SDI mapping scheme in the reception device 30 on the basis of the SDI mapping scheme for the input video and the RP 2110-23 compatibility of the transmission device 10 and the reception device 30.

In step S54, the control device 50 transmits the SDI mapping scheme to the reception device 30.

In step S55, the control device 50 transmits the ST 2110 mapping scheme to the transmission device 10.

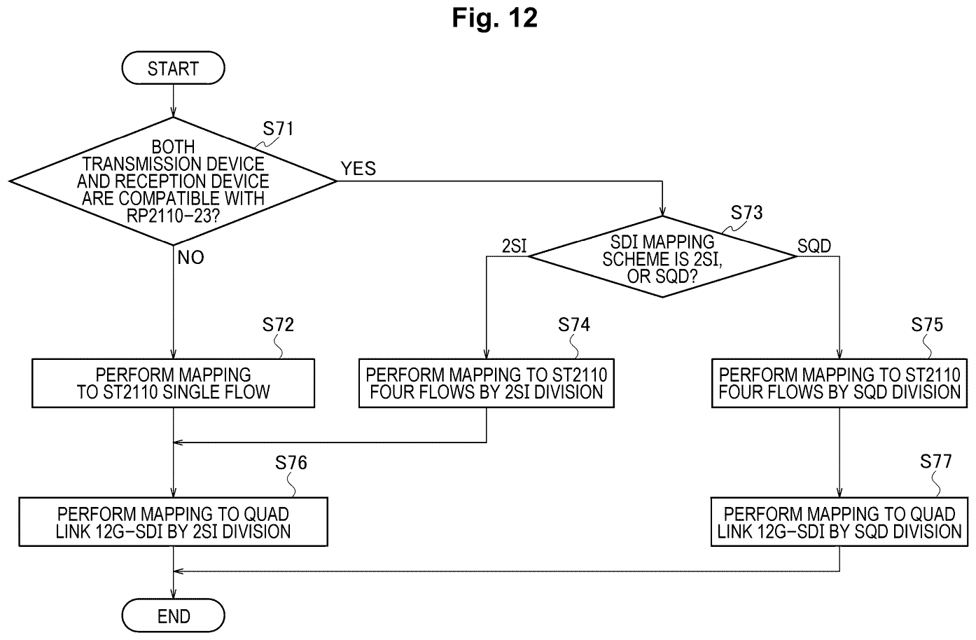

An example of a flow of processing performed by the control device 50 will be described with reference to a flowchart illustrated in FIG. 12. It is assumed that the control device 50 has received the SDI mapping scheme for the input video and the RP 2110-23 compatibility of the transmission device 10 and the reception device 30.

In step S71, the control device 50 determines whether or not both the transmission device 10 and the reception device 30 are compatible with the RP 2110-23.

In a case where either the transmission device 10 or the reception device 30 is not compatible with the RP 2110-23, in step S72, the control device 50 selects the single flow as the ST 2110 mapping scheme for the transmission device 10.

In a case where both the transmission device 10 and the reception device 30 are compatible with the RP 2110-23, in step S73, the control device 50 determines whether the SDI mapping scheme for the input video is the 2SI scheme or the SQD scheme.

In a case where the SDI mapping scheme is the 2SI scheme, in step S74, the control device 50 selects the 2SI scheme as the ST 2110 mapping scheme for the transmission device 10.

In a case where the SDI mapping scheme is the SQD scheme, in step S75, the control device 50 selects the SQD scheme as the ST 2110 mapping scheme for the transmission device 10.

The control device 50 transmits the ST 2110 mapping scheme selected in steps S72, S74, and S75 to the transmission device 10.

In a case where the single flow or the 2SI scheme is selected as the ST 2110 mapping scheme, in step S76, the control device 50 selects the 2SI scheme as the SDI mapping scheme for the reception device 30.

In a case where the SQD scheme is selected as the ST 2110 mapping scheme, in step S77, the control device 50 selects the SQD scheme as the SDI mapping scheme for the reception device 30.

The control device 50 transmits the SDI mapping scheme selected in steps S76 and S77 to the reception device 30.

As described above, the transmission device 10 of the present embodiment is a video transmission device that stores pixel data of a picture input from a serial digital interface in a packet and transmits the packet. The transmission device 10 includes: the SDI input unit 11 that inputs a plurality of sub-pictures obtained by dividing the picture from a plurality of links of the SDI; the mapping management unit 12 that selects an ST 2110 mapping scheme for the pixel data to the packet on the basis of a combination of an SDI mapping scheme for the pixel data in the SDI and the RP 2110-23 compatibility; and the ST 2110 output unit 13 that stores the pixel data of the picture in the packet in accordance with the ST 2110 mapping scheme and outputs the packet. The reception device 30 of the present embodiment is a video reception device that outputs pixel data of a picture stored in a packet from an SDI.

The reception device 30 includes: the ST 2110 input unit 31 that inputs the packet in which the pixel data is stored; the mapping management unit 32 that selects an SDI mapping scheme for the pixel data to a plurality of links of the SDI on the basis of a combination of an ST 2110 mapping scheme for the pixel data in the packet and the RP 2110-23 compatibility; and the SDI output unit 33 that outputs the pixel data of the picture from the plurality of links of the SDI in accordance with the SDI mapping scheme. As a result, the SDI and the ST 2110 can be converted with a low delay.

In addition, the transmission device 10 and the reception device 30 determine the mapping scheme on the basis of a correlation between the plurality of sub-pictures. As a result, the mapping scheme for the input pixel data can be automatically determined.

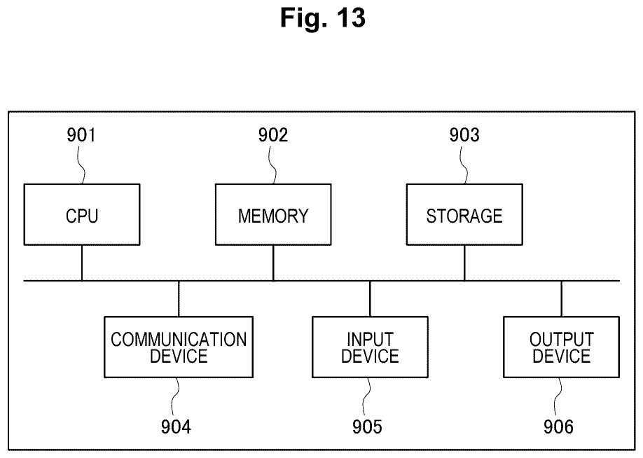

As the transmission device 10, the reception device 30, and the control device 50 described above, it is possible to use a general-purpose computer system including a central processing unit (CPU) 901, a memory 902, a storage 903, a communication device 904, an input device 905, and an output device 906 as illustrated in FIG. 13, for example. In the computer system, the CPU 901 executes a predetermined program loaded on the memory 902, whereby the transmission device 10, the reception device 30, and the control device 50 are implemented. The program can be recorded on a computer-readable recording medium such as a magnetic disk, an optical disk, or a semiconductor memory, or can be distributed via a network.

### REFERENCE SIGNS LIST

10 transmission device
11 SDI input unit
12 mapping management unit
13 ST 2110 output unit
30 reception device
31 ST 2110 input unit
32 mapping management unit
33 SDI output unit
50 control device

1. A video transmission device that stores pixel data of a picture input from a serial digital interface in a packet and transmits the packet,
the video transmission device comprising one or more processors configured to perform operations comprising:
inputting a plurality of sub-pictures obtained by dividing the picture from a plurality of links of the serial digital interface;
selecting a second mapping scheme for storing the pixel data in the packet on a basis of a combination of a first mapping scheme for the pixel data in the serial digital interface and presence or absence of a multi-flow transmission function of the video transmission device itself; and
storing the pixel data of the picture in the packet in accordance with the second mapping scheme and outputting the packet.

2. The video transmission device according to claim 1, wherein the operations comprising:
determining the first mapping scheme for the pixel data in the serial digital interface on a basis of a correlation between the plurality of sub-pictures.

3. A video reception device that outputs pixel data of a picture stored in a packet from a serial digital interface,
the video reception device comprising one or more processors configured to perform operations comprising:
inputting the packet in which the pixel data is stored;
selecting a first mapping scheme for the pixel data in the serial digital interface on a basis of a combination of a second mapping scheme for the pixel data stored in the packet and presence or absence of a multi-flow reception function of the video reception device itself; and
outputting the pixel data of the picture from a plurality of links of the serial digital interface in accordance with the first mapping scheme.

4. The video reception device according to claim 3, wherein the operations comprise:
determining the second mapping scheme for the pixel data stored in the packet on a basis of a correlation between a plurality of sub-pictures obtained by dividing the picture.

5. A video transmission method by a video transmission device that stores pixel data of a picture input from a serial digital interface in a packet and transmits the packet,
the video transmission method comprising:
inputting a plurality of sub-pictures obtained by dividing the picture from a plurality of links of the serial digital interface;
selecting a second mapping scheme for storing the pixel data in the packet on a basis of a first mapping scheme for the pixel data in the serial digital interface and presence or absence of a multi-flow transmission function of the video transmission device itself; and
storing the pixel data of the picture in the packet in accordance with the second mapping scheme and outputting the packet.

6. (canceled)

7. (canceled)

8. A non-transitory computer readable medium storing one or more instructions for causing a computer to operate as the video transmission device according to claim 1.
